(19) United States
(12) Patent Application Publication
(10) Pub. No.: US 2006/0114520 A1
(43) Pub. Date: Jun. 1, 2006

(54) Image forming method and image forming apparatus

(75) Inventors: Jun Enomoto, Kanagawa (JP); Takayuki Iida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/288,225

(22) Filed: Nov. 29, 2005

(30) Foreign Application Priority Data
Nov. 29, 2004 (JP) 2004-343616
Nov. 29, 2004 (JP) 2004-343670
Nov. 29, 2004 (JP) 2004-344060

(51) Int. Cl. H04N 1/40

(52) U.S. Cl. 358/448

(57) ABSTRACT

A method of forming an image by performing image processing on each of optically photographed images that belong to one group is provided. The method comprises the steps of: performing the first image processing and then the second image processing on a specific image out of all the images in one group to create a processed image; storing, in a given memory, at least one image including the specific image out of all the images in one group as an unprocessed image on which at least the second image processing has not been performed; and reading the specific image stored as the unprocessed image in the memory to output, along with the processed image, a half-processed specific image which is obtained by performing the first image processing but not the second image processing on the specific image. Specifically, the half-processed specific image is stored in the memory as an unprocessed image. In creating the processed image by performing the first image processing and the second image processing on the specific image and outputting the processed image, the half-processed specific image is read out of the memory, in concert with the progress of the second image processing for creating the processed image, to be outputted with the processed image, thereby providing a promotion print where the half-processed specific image and the processed image is recorded for promoting customers an effectiveness of the second image processing.

The entire contents of literatures cited in this specification are incorporated herein by references.

### BACKGROUND OF THE INVENTION

The present invention belongs to a technical field of image formation for outputting a photo print or the like, and relates to an image forming method and an image forming apparatus which make a customer who orders a photo print or the like of an image aware that high grade image processing such as red eye correcting processing has been performed on an output of the image.

Digital photo printers have lately been available for practical use. Digital photo printers photoelectrically read an image recorded on a photographic film, convert the read image into digital signals, perform various kinds of image processing to create digital image data for recording from the digital signals, expose photosensitive material to recording light that is modulated in accordance with the image data, and then output it as a print.

Digital photo printers handle digital image data which is obtained by photoelectrically reading an image caught on film to be subjected to image processing and developed on photosensitive material through exposure. In addition to digital data of an image caught on film, digital photo printers also handle data of an image taken by a digital camera or the like and create a print from such image data.

In digital photo printers, image processing (correction and adjustment of an image) is accomplished by processing image data since images are handled as image data.

Digital photo printers therefore have far more freedom in performing image processing such as color/density correction, gray scale correction, saturation correction, sharpness controlling processing, and dodging processing (processing for rendering the effect of dodging by adjusting an image's dynamic range while maintaining the intermediate gray scale level) than conventional analog exposure printers (printers that expose photosensitive material (printing paper) with light projected onto film), which enables digital photo printers to reproduce a high quality image stably irrespective of whether it is over exposure, under exposure, a backlit scene, or a high-contrast scene, for example.

It is also through processing of image data that digital photo printers accomplish such image processing as red eye correction (correction of the red eye phenomenon caused by flash photography), correction of darkening around a photo's edge (correction of non-uniform density caused by vignetting of a photographic lens), aberration correction (correction of distortion resulting from aberration of a photographic lens), and dust/scratch removal processing (correction of defective pixels due to scratches or dust on a photographic film or lens, or the like), which demand operators of analog exposure printers to be extremely skilled, or which are very difficult or practically impossible for analog exposure printers.

The former set of image processing (color/density correction, gray scale correction, saturation correction, sharpness controlling processing, and dodging processing) gives an image sufficiently high image quality in terms of photo image quality. In other words, a print can be finished as a product by the former set of image processing alone.

The latter set of image processing (red eye correction, correction of darkening around a photo's edge, aberration correction, and dust/scratch removal processing) is for mending image defects, which are a different matter from photo image quality.

Each image processing in the former set (the one including color/density processing) is completed in a relatively short period of time since image processing conditions and the like can be set by analyzing low resolution image data such as pre-scan data or thinned image data and there is not so much to compute.

On the other hand, red eye correction and dust/scratch removal processing need analysis of image data having as high a resolution as the final output and a lot of complicated computation. Aberration correction and correction of darkening around a photo's edge also need information that varies depending on what photographic lens is employed, and a great deal of complicated computation.

It can be said that the latter set of image processing (the one including red eye correction and correction of darkening around a photo's edge) is high grade image processing as opposed to normal image processing in which color, density, gray scale or the like is corrected in order to give an image a proper finish.

Through such high grade image processing, digital photo printers fully utilize the advantages of digital exposure and output a high quality print with image defects corrected. However, high grade image processing takes time and requires a sophisticated system.

Customers (orderers of photo prints) appreciate finished prints but not the effects of high grade image processing such as red eye correction; usually they do not even notice the fact that such high grade image processing has been performed on the prints.

Therefore, when a sophisticated image processing system is used to perform time-consuming high grade image processing and obtain a higher image quality finish than a finish provided by an ordinary photo laboratory system or processing system, it is very difficult to make that fact known to and valued by customers.

As a solution to this problem, JP 2003-205660 A discloses a printing method in which one of images ordered to be made into prints by a customer at a time is picked up to output a digitally-enhanced (quality improvement/reinforcement) print of this image and a non-enhanced print of this image both.

According to this printing method, the fact that the outputted print has thereon a high quality image reproduced by image processing can be recognized and appreciated by the customer.

However, this printing method is not a foolproof way of presenting the effects of high grade processing such as red eye correction, dust/scratch removal processing, correction of darkening around a photo's edge, and aberration correction well enough to make customers acknowledge the effects. Thus it has not been possible to form, with efficiency, an image that shows the effects of high grade processing satisfactorily.

### SUMMARY OF THE INVENTION

The present invention has been made to solve the above-described problem of prior art, and an object of the present invention is therefore to provide an image forming method capable of ensuring that red eye correction or other time/labor-consuming, high-grade image processing performed on an output of an image that is photographed on a photographic film, or an image that is taken by a digital camera or the like, is demonstrated to and acknowledged by a customer who orders a print of the image, as well as being capable of efficient image output, and an image forming apparatus that embodies this image forming method.

The present invention provides a method of forming an image by performing image processing on each of optically photographed images that belong to one group, comprising the steps of:

performing first image processing and then second image processing on a specific image out of all the images in one group to create a processed image; storing, in a given memory, at least one image including the specific image out of all the images in one group as an unprocessed image on which at least the second image processing has not been performed; and reading the specific image stored as the unprocessed image in the memory to output, along with the processed image, a half-processed specific image which is obtained by performing the first image processing but not the second image processing on the specific image.

In the image forming method, it is preferable that the half-processed specific image is stored in the memory as an unprocessed image and in creating the processed image by performing the first image processing and then the second image processing on the specific image and outputting the processed image, the half-processed specific image is read out of the memory, in concert with the progress of the second image processing for creating the processed image, to be outputted with the processed image.

Alternatively, it is preferable that an unprocessed specific image that has not received the first image processing is stored in the memory, and in creating the processed image by performing the first image processing and then the second image processing on the specific image and outputting the processed image, the unprocessed specific image that has not received the first image processing is read out of the memory in concert with the progress of the second image processing for creating the processed image, the first image processing is performed on the read image to create the half-processed specific image, and the half-processed specific image are outputted with the processed image.

Also preferably, the specific image is chosen out of all the images in one group in accordance with an inputted instruction, and the memory stores the chosen half-processed specific image, which has not received the second image processing.

Still also preferably, the memory stores half-processed images of all images in one group except an image for which the second image processing is judged as unnecessary from information on the image, the specific image is automatically chosen, out of the half-processed images that the memory stores, in accordance with the result of analyzing information on the image in a preset manner. More preferably, the information on the image is one of image data, the image's shooting information, and both thereof.

It is also preferable that all the images in one group, including the specific image, are stored in the memory.

In the invention, one of a first mode and a second mode may be chosen to form an image, wherein, in the first mode, the specific image is chosen out of all the images in one group in accordance with an inputted instruction, and the memory stores the unprocessed specific image that has not received the second image processing, and wherein, in the second mode, the memory stores such an unprocessed image that has not received the second image processing and that is not an image for which the second image processing is judged as unnecessary from information on the image, and the specific image is automatically chosen, out of images stored in the memory, in accordance with an analysis result obtained by analyzing information on the image.

Alternatively, one of a first mode and a second mode mey be chosen to form an image, wherein, in the first mode, the specific image is chosen out of all the images in one group in accordance with an inputted instruction, and the memory stores the unprocessed specific image that has not received the second image processing, and wherein, in the second mode, the memory stores all unprocessed images in one group that have not received the second image processing.

The second image processing may be processing for analyzing information on an image and repairing a defect of an image when an image defect is detected in the image from the result of analyzing information on the image.

The second image processing may include at least one correction selected from the group consisting of red eye correction, dust/scratch removal, aberration correction due to a lens used to photograph an image, and correction of darkening around an image's edge due to a lens used to photograph the image.

In outputting the half-processed image with the created processed image, each of a hard copy on which the processed image is reproduced and a hard copy on which the half-processed specific image is reproduced may be outputted to an identical type of recording medium by an identical image recording method.

The recording medium may be printing paper.

The processed image may be reproduced on one side of a hard copy and the specific image in an unprocessed state may be reproduced on the other side of the hard copy.

In the invention, the specific image is preferably a reference image with which the effect of the second image processing is measured, and is automatically chosen out of all the images in one group by analyzing information on the image. Here, more preferably, the specific image is automatically chosen in accordance with the result of analyzing information on the image, and the memory stores such an unprocessed specific image that has not received the second image processing and that is other than an image for which the second image processing is judged as unnecessary from the analysis result, or the memory stores all the unprocessed images in one group are fed to the memory. Then, after all images in one group are stored in the memory, the specific image is chosen out of all the images fed. Preferably, all the images in one group receive the second image processing in an order that the images are fed, a first image of the images in one group that has received the second image processing earlier than any other images in the group is evaluated in accordance with a preset determination standard from the result of the image processing, and the result of the evaluation is stored in the memory, and a second and subsequent processed images on which the second image processing has been performed are sequentially evaluated in accordance with the determination standard, and a process in which, each time the evaluation is made, the result of the evaluation is compared against the evaluation result stored in the memory to store the higher one of the two evaluations in the memory is repeated until the processed image that has been fed last is evaluated, and an image whose evaluation result remains stored in the memory at the end is chosen as the specific image.

The present invention may further comprises the step of checking whether the half-processed specific image is effective in demonstrating the effect of the second image processing, wherein, when the half-processed specific image is confirmed to be effective, the specific image is reproduced and, when the specific image is found to be ineffective, a new specific image is formed under different conditions from conditions under which the ineffective specific image is formed.

The forming of a new specific image is preferably repeated until the repetition count reaches a given number of times, and if an effective specific image is not obtained at that point, an attempt to form a half-processed specific image anew is stopped.

The forming of a new specific image is preferably performed by changing at least one of previous conditions of forming the half-processed specific image, a format of reproducing the half-processed specific image, and an image to be selected as the specific image.

The second image processing may be red eye correction in which red eye in an image is detected to correct the detected red eye, and the effectiveness of the specific image in demonstrating the effect of the second image processing may be judged by whether the specific image has detectable red eye, and the specific image may be deemed as effective when red eye is detected whereas the specific image is deemed as ineffective when red eye is not detected.

The present invention also provide an image forming apparatus, comprising: an image obtaining section for obtaining, in groups, optically photographed images, each group containing plural images; a processing section for executing, on an obtained image, one of first image processing, second image processing, and both, in which case the second image processing is performed after the first image processing; a selection section for selecting, by analyzing information on images, which of the images in one group is to serve as a specific image, the specific image being a reference image with which the effect of the second image processing is demonstrated; a memory for storing an image chosen by the selection section as a specific image or all images fed including the specific image; and a sorting section for sending, to the memory, all the images in one group, or all the images in one group except an image for which the second processing is judged as unnecessary from the result of analyzing information on the image, in one of a state before the first processing image is performed and a half-processed state in which the first image processing alone has been performed, and an image that is chosen by the selection section as a specific image is read out of the memory, and a half-processed specific image which is obtained by performing the first image processing but not the second image processing at the processing section is outputted along with a processed image which is obtained by performing the first image processing and the second image processing on the specific image at the processing section.

In the present invention, preferably, the memory stores all images fed, and the selection section selects the specific image after images in one group are all fed to the memory.

Also preferably, images are fed to the processing section sequentially to receive the second image processing, and the memory stores at least one image in one group, and also stores result of evaluation made on the stored image to evaluate the effect of the second image processing in accordance with an evaluation standard, and the selection section obtains the result of evaluation made in accordance with the evaluation standard on processed image, which have sequentially been fed and received the second image processing, and, each time the evaluation is made, the result of the evaluation is compared against an image's evaluation result stored in the memory, an image that is evaluated higher than the other is stored in the memory as the specific image, thereby replacing the previously stored image, and the selection section ultimately determines, as a specific image, an image that remains stored in the memory when the evaluation result comparison is finished for the image that has been fed last out of the fed images.

The present invention provides an image forming apparatus, comprising: an image obtaining section for obtaining, in groups, optically photographed images, each group containing plural images; a processing section for executing, on an obtained image, one of first image processing, second image processing, and both, in which case the second image processing is performed after the first image processing; a selection section for selecting, from images in one group, at least one image as a specific image; and a memory for storing an unprocessed image that has not received the second image processing; wherein the specific image is stored as an unprocessed image in the memory, the specific image is read out of the memory, and a half-processed specific image which is obtained by performing the first image processing but not the second image processing is outputted with a processed image which is obtained by performing the first image processing and the second image processing on the specific image.

In the present invention, preferably, the memory stores the half-processed specific image and the half-processed specific image is read out of the memory and outputted.

Preferably, the memory stores as the unprocessed image the specific image which has not received the first image processing, and the stored unprocessed specific image is read out of the memory to receive the first image processing before outputted.

Also preferably, the selection section has at least one of a first selection section for selecting the specific image in accordance with an instruction inputted by an operator and a second selection section for selecting the specific image by analyzing information on the image.

Still also preferably, the selection section has a first selection section for selecting the specific image in accordance with an instruction inputted by an operator, and a second selection section for selecting the specific image by analyzing information on the image, and which one of the selection sections is to operate is selected.

Structured as above, the present invention can make a customer who orders a print or image file of an image aware that time/labor-consuming, high-grade image processing has been performed on an output of the image. The present invention is also capable of outputting, with excellent efficiency, an image that can demonstrate such effects.

Examples of high grade image processing include red eye correction, correction of an image's defected portions (pixels) due to dust clung to a film or a lens or scratches on a film or a lens, correction of image distortion resulting from aberration of a lens used to take the image, and correction of density lowered around the edge by vignetting of a lens used to take the image.

Accordingly, with the present invention, high grade image processing and works such as red eye correction can be demonstrated to and acknowledged by customers without fail, which makes it possible to give an added value to an image (product), and discriminate the image from one on which high grade image processing is not performed. A photofinishing laboratory that employs the present invention can thus stand out among other stores, compete with other stores in price, and gain and keep new customers.

### BRIEF DESCRIPTION OF THE DRAWINGS

In the accompanying drawings:

FIGS. 1A and 1B are diagrams showing the structure of an image forming apparatus according to the present invention;

FIGS. 2A and 2B are diagrams showing an embodiment of an image forming method according to the present invention;

FIG. 3 shows template examples of an image formed by the image forming method of the present invention;

FIG. 4 is an explanatory diagram illustrating an example of a red eye correction method according to the present invention;

FIGS. 5A and 5B are diagrams showing another embodiment of the image forming method according to the present invention;

FIG. 6 is a diagram showing another embodiment of the image forming method according to the present invention;

FIG. 7 is a flow chart illustrating an embodiment of the image forming method according to the present invention; and

FIG. 8 is a flow chart illustrating another embodiment of the image forming method according to the present invention.

### DETAILED DESCRIPTION OF THE PREFERRED EMBODIMENTS

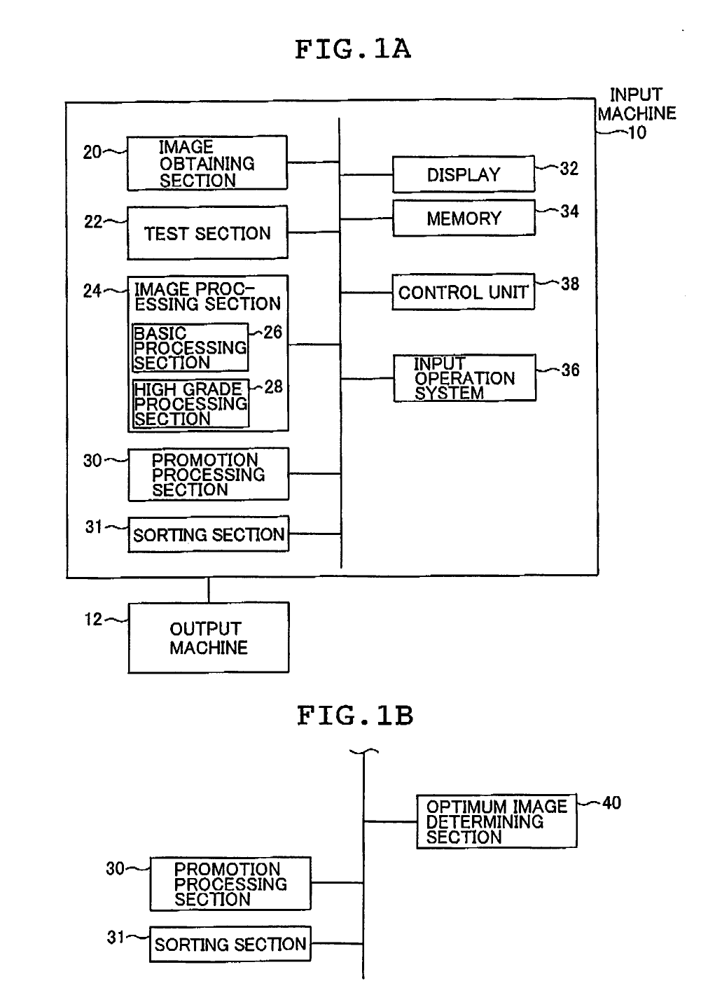

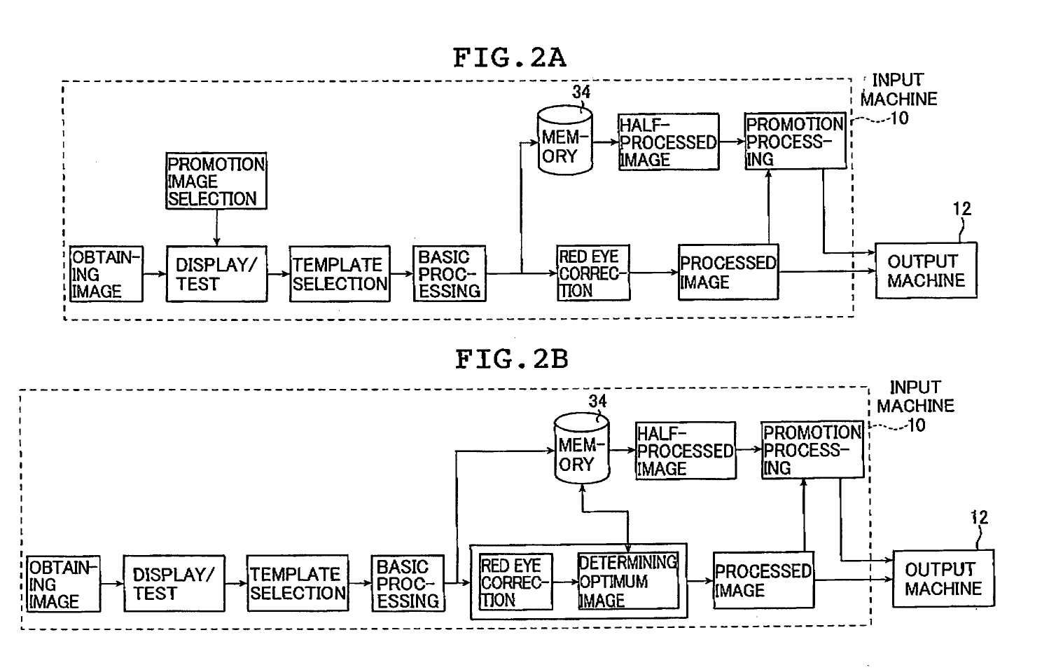

FIG. 1A is a structural diagram showing an embodiment of an image forming apparatus according to the present invention. A digital photo printer is composed of an input machine 10, which creates from an obtained image (image data) an output image (image data), and an output machine 12, which outputs a print on which the output image is reproduced. The input machine 10 corresponds to the image forming apparatus of the present invention.

The input machine 10 shown in FIG. 1A as an embodiment of the image forming apparatus has an image obtaining section 20, which obtains an image (image data) from an external equipment, a test section 22, which creates a simulation image through simulation processing for displaying a test image on a test screen in accordance with the obtained image, an image processing section 24, which performs image processing in accordance with the tested image, a promotion processing section 30, which performs promotion processing on a promotion subject image (specific image) chosen from images as will be described later, a sorting section 31, which sorts images, a display 32, which displays each screen, a memory 34, an input operation system 36, which is composed of a mouse, a keyboard, and the like, and a control unit 38, which controls and manages functions of the input machine 10. The image processing section 24 has a basic processing section 26 for executing basic processing, which will be described later, and a high grade processing section 28 for executing high grade processing, which will be described later.

The input operation system 36 corresponds to a selection portion used to manually select a promotion subject image, which will be described later.

FIG. 2A shows a processing flow that is employed by the input machine 10 shown in FIG. 1A to carry out an image forming method of the present invention. In the processing an embodiment shown in FIG. 2A, a promotion subject image described later is set based on a manual input.

The image obtaining section 20 of the input machine 10 obtains an image (image data) that is photographed on a photographic film and then photoelectrically read by a scanner. Alternatively, the image obtaining section 20 obtains an image (image data) picked up by an image pickup device such as a digital camera or a cellular phone with a photographic function from the image pickup device, or from a storage medium such as Smart Media™ or PC Card™ where an image taken by the image pickup device is stored, or from various communication networks to which a personal computer, a print order receiving terminal, or the like is connected, or from other image data sources.

Obtaining an image, the input machine 10 displays on the display 32 a test image (finish simulation image) in order to test a simulation image processed at the test section 22. After the test is completed, the image processing section 24 gives the data necessary image processing (basic processing and high grade processing described later), and outputs the processed image to the output machine 12 as an output image (image data). Testing is not always conducted and the input machine 10 may not necessarily have a test function.

The image obtaining section 20 may only have a function relevant to formation of an image photographed on a photographic film and then digitally fed, or may only have a function relevant to formation of an image (image data) taken by a digital camera or the like, or may have both of the functions. The digital photo printer may have plural input machines 10 connected to one or more output machines 12.

The output machine 12 receives an output image from the input machine 10 and, after pulling out printing paper (photosensitive material) which is, for example, wound into a roll, and cutting the printing paper into a piece sized to the print size, carries the piece of printing paper forward for two-dimensional scan exposure with recording light (e.g., laser light), which is modulated in accordance with the image fed from the input machine 10. A latent image is thus formed. The exposed printing paper receives given wet processing, and is dried to be outputted as a (finished) photo print. Images outputted as photo prints are sorted by grouping together images that have been ordered by a customer at a time.

Instead of outputting an output image to the output machine 12, or in addition to outputting an output image to the output machine 12, the input machine 10 may group together output images ordered by the same customer at a time to record the grouped images in a storage medium, or to output the grouped images to an external apparatus via a communication network or the like.

In the present invention, one or more images which become promotion images for demonstrating the effect of high grade processing are chosen as promotion subject images (reference images for demonstrating the effects of high grade processing) out of images in one order that receive image processing (basic processing and high grade processing) before outputted. For each selected promotion subject image, a promotion image which receives basic processing but not high grade processing is created in addition to an output image (product image or processed image) on which basic processing and high grade processing are performed. In order to facilitate comparison between the product image and the promotion image, an image designed to contain both the product image (processed image) and the promotion image is outputted.

Basic processing (first image processing) is elementary image processing performed to output an image that has proper color/density (tone reproduction, color reproduction), image structure (sharpness, graininess), and the like. Through the basic processing, an image gets photo image quality, and becomes a completed image which corresponds to such an image output as a normal print output where high grade processing is not performed. Examples of the basic image processing include image enlargement or reduction (processing of electronically varying the magnification power), gray scale correction, color/density correction, saturation correction, sharpness controlling processing, and dodging processing (compression or extension of the image density dynamic range while maintaining the image's gray scale level).

On the other hand, high grade processing (second image processing) is image processing for correcting image defects (degradation) and corrects only images that have defects. Preferably, high grade processing is image processing for correcting only images in which defects are detected as a result of analyzing image-related information. Specific examples of high grade processing include correction of red eye caused by flash photography (red eye correction), correction of an image's defective portions (pixels) due to foreign objects on a photographic film or lens or scratches on a photographic film or a lens (dust/scratch removal processing), correction of image distortion resulting from aberration of a photographic lens (lens aberration correction), and correction of density dropped around a photo's edge by vignetting of a photographic lens (correction of darkening around a photo's edge), In the present invention, the term image-related information refers to information of an image (image data) itself and shooting information of the image.

Specific examples of shooting information include the presence or absence of light from a flash upon shooting, information of a camera (lens) that has been used to take the image, information of a photographic film on which the image has been photographed, information about the aperture used in shooting, and information about the shutter speed. To form an image from an APS film, for example, shooting information is obtained from magnetic information recorded on the APS film. In the case of an image photographed by a digital camera or the like, shooting information is obtained from information recorded in the image's file.

A description is given below on an example of the image forming method shown in FIG. 2A in which red eye correction is performed as high grade processing.

In the following description, for convenience's sake, a processed image, which receives basic processing and high grade processing both (including a case in which analysis of image-related information is carried out but not correction), is reproduced and a promotion image, which is formed from an image that receives only basic processing (a half-processed image), is also reproduced. A print on which a promotion image is reproduced is referred to as promotion print.

The image forming method shown in FIG. 2A employs an embodiment in which an operator selects a promotion subject image from which a promotion image is to be created (manual selection of a promotion subject image).

Obtaining all or some of images (image data) in one order, the image obtaining section 20 has the display 32 display a test image processed and created at the test section 22, thereby prompting an operator to execute testing. The test image receives image processing (simulation processing) according to basic processing. Image processing conditions of basic processing are set by, for example, analyzing the original image of the test image and, if a color/density adjustment or the like is made as a result of testing, are changed accordingly.

In the example shown in the drawing, a screen to display a test image on the display 32 doubles as a promotion subject image selecting screen on which an input to designate a promotion subject image is entered with the input operation system 36 and a known technique such as a GUI (Graphical User Interface). Other selections described below are employed in the same manner. The input machine 10 responds to the input by choosing the designated image as a promotion subject image. A single frame or plural frames may be chosen by the promotion subject selection (inputted designation). The operator may use an automatic selection standard, which will be described later, in selecting a promotion subject image.

In the case where promotion subject image selection is omitted from processing of images in one order, no promotion image is formed (no promotion print described later is outputted) for this order. In the case where testing is omitted, images which has received image processing are displayed for selection of a promotion subject image.

A test image is displayed in the same way a conventional digital photo printer displays a test image. Specifically, when an image on film is read by a scanner and fed to the image obtaining section 22, an image obtained through pre-scan, which precedes fine scan for reading an output image, is used to display a test image. In the case of an image photographed by a digital camera or the like, the obtained image is thinned (or reduced) by skipping portions of the image, and the resultant image is used to display a test image.

Testing is not an indispensable operation, and the digital photo printer may output an image without conducting testing. Two operation modes, a normal mode in which testing is conducted and an automation mode which omits testing, may be set so that one of the two modes can be chosen.

In the case of reading from film with a scanner, fine scan may be conducted after testing is finished, or may immediately follow pre-scan so that pre-scan and fine scan are executed in succession.

After a promotion subject image is chosen, the input machine 10 next displays a template selecting screen for selecting a template, which serves as a promotion print form (format), thereby prompting the operator to choose a template. A template may be selected immediately after a promotion subject image is chosen, or after all images in one order are tested.

On the template selecting screen, template types are displayed in drawings and/or text to be selected in accordance with an instruction inputted through the input operation system 36 with a GUI or the like. The result of the template selection is provided to promotion processing, which will be described later.

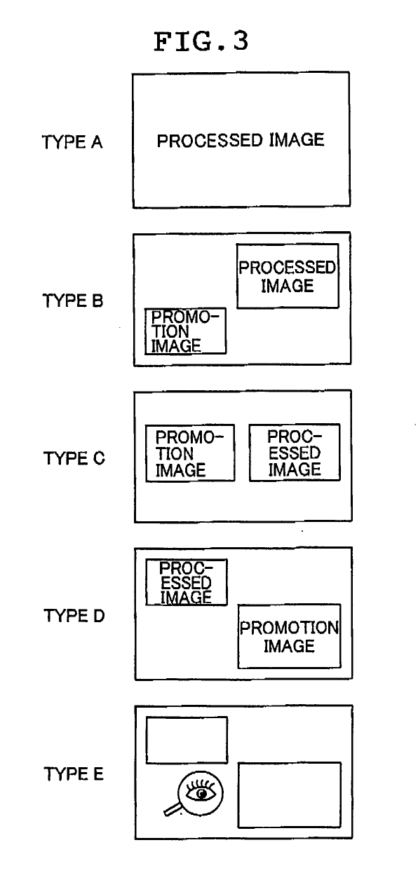

Four types of template are prepared as shown in FIGS. 3A to 3D and selected suitably. FIG. 3A shows a template for reproducing a promotion subject image alone on one print (a type A template). FIG. 3B shows a template for reproducing, on one print, a processed image and a promotion image sized smaller than the processed image (a type B template). FIG. 3C shows a template for reproducing, on one print, a processed image and a promotion image which are of the same size (a type C template). FIG. 3D shows a template for reproducing, on one print, a processed image and a promotion image sized larger than the processed image (a type D template).

Although four types of template are prepared here as described above, the present invention is not limited thereto. There may be five or more types of templates, or three, two, or less. Images on a template can be arranged and sized arbitrarily.

In a preferred embodiment, there are plural types of template to choose from. However, the present invention is not limited thereto and only one promotion print template may be prepared. Also, a special template may be prepared for specific high grade processing performed, such as a red eye correction template.

After a promotion print template is chosen, the basic processing section 26 sequentially performs basic processing on frame images in one order. These images correspond to outputs, which are images read through fine scan (fine scan data) in the case of producing a print from a photographic film, and are photographed images (photographed image data) in the case of producing a print of an image picked up by a digital camera or the like. The images receive, as basic processing, image enlargement or reduction, gray scale correction, color/density correction, saturation correction, sharpness controlling processing, and dodging processing.

Each method processing listed as basic processing can be performed by a known method.

After receiving basic processing, all images in one order are sequentially subjected to red eye correction (high grade processing) at the high grade processing section 28. The image chosen as a promotion subject image is fed to the high grade processing section 28 where red eye correction is performed and, at the same time, a half-processed image (image that receives only basic processing) of this image is sent to and stored in the memory 34.

In the case where shooting information is obtained before basic processing is started and the sorting section 31 knows from the result of analyzing the shooting information that an image is photographed without a flash, red eye correction halts at this point for the image that is free from the red eye phenomenon because no flash is used upon shooting (an image that does not need red eye correction, hereinafter referred to as non-red eye image). Without receiving image correction, a non-red eye image is deemed as a processed image on which basic processing and red eye correction (high grade processing) have been performed, and the high grade processing section 28 does not perform red eye correction on this image.

No particular limitation is put on how to correct red eye, and various known methods can be employed. One method is given below as a preferred example.

The first step of this preferred red eye correction method is to detect a red eye candidate (an area that may have red eye) within an image on which basic processing has been performed, and then obtain position information (central coordinate position information) of the red eye candidate, area information, information on how many red eye candidates are detected, and the like.

An image in which no red eye candidate is detected through this red eye candidate detection is deemed as a non-red eye image, and red eye correction on the image halts at this point. Without receiving image correction, the non-red eye image is treated as processed image on which basic processing and red eye correction have been performed.

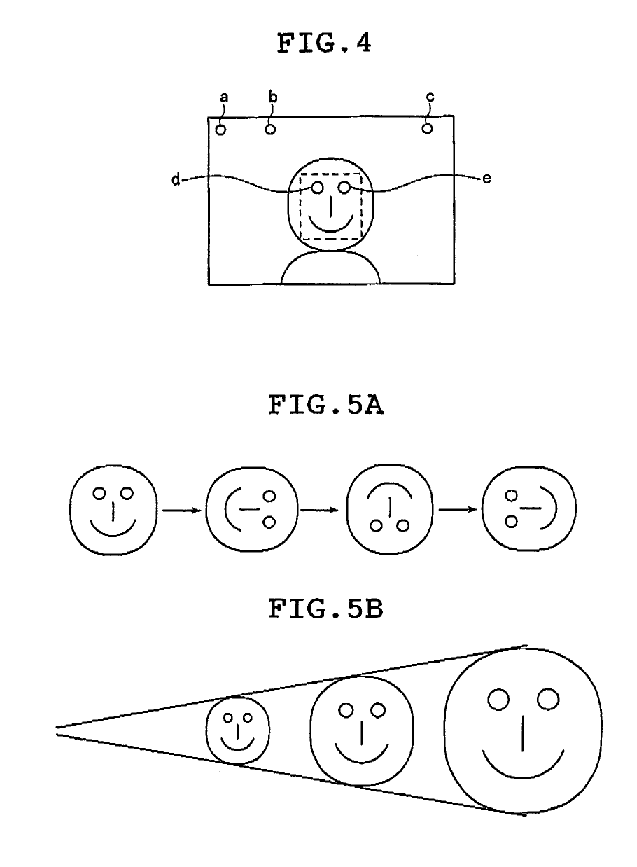

For instance, when a person is photographed against a scene that has three red lamps in the back as shown in FIG. 4 and the red eye phenomenon happens to the person in the image (scene), areas a, b and c, where the red lamps are located, and areas d and e, where red eye actually has taken place, are detected as red eye candidates.

No particular limitation is put on how to detect red eye, and various known methods can be employed.

For example, red eye's color information (that a red eye area has red color information) and shape information (that a red eye area has a round shape) are used to extract a round area that has the hue of red and a given number of pixels or more. In another example, a standard indicating the degree of red eye (how much the color of an area resembles the color of red eye) and the degree of roundness (how round the area is) is created in advance from many red eye image samples, and an area that exceeds thresholds of the degree of red eye and the degree of roundness according to this standard is detected as a red eye candidate, which has a possibility of being red eye.

From the result of the red eye candidate detection (e.g., the position information described above), face detection is performed on a surrounding area containing a detected red eye candidate.

In the example shown in FIG. 4, face detection is performed on an area of given size that contains a red eye candidate for each of the areas a, b, c, d, and e one at a time. An area enclosed by a dotted line, for example, is detected as a face area, and information informing that the areas d and e are contained in the face area is obtained. This information is obtained alone or combined with information of the detected face area.

No particular limitation is put on how to detect the face area, and various known methods can be employed.

A preferred method uses an average face image created in advance from many face image samples, a face template, so to speak, to detect the face area through template matching.

In this method, for example, the direction of the face in a face template (or the image on which face detection is being performed) is changed by rotating the template by 90° at a time (0°→90°→180°→270°) as shown in FIG. 5A to match the direction in which the image has been photographed (the vertical, horizontal, or other position the camera has been in upon shooting). At the same time, the size of the face in the face template (or the image on which face detection is being performed) is changed (enlarged/reduced=resolution conversion) as shown in FIG. 5B to match the size (resolution) in the image. Plural face templates having different combinations of face directions and face sizes are sequentially compared against a face candidate area in the image to check the degree of matching and thus detect the face area.

Instead of rotating and enlarging/reducing a face template, variations of a face template may be created in advance by varying the face of the original face template in direction and size, and used to check the degree of matching. A face candidate area compared against a face template to check the degree of matching is detected by, for example, skin color extraction or outline extraction.

The face area can be detected by other methods than this template matching method.

Another preferred face detection method uses a learning technique. This method involves preparatory learning in which many face images and non-face images are prepared to extract the feature amount of each image, and a function or threshold for discriminating a face image from a non-face image is calculated from the result of the extraction with the use of a suitably chosen learning technique. In the subsequent face detection, the feature amount of an image on which face detection is performed is extracted as in the preparatory learning, and the function or threshold obtained in the preparatory learning is used to determine whether a face candidate area is a face area or a non-face area.

Other employable face detection methods are: ones that are disclosed in JP 08-184925 A and JP 09-138471 A and that employ shape identification by edge (outline) extraction or edge direction extraction, or color identification by skin color extraction, black color extraction, or a combination of shape identification and color identification; and face candidate area detection methods introduced in JP 2000-137788 A, JP 2000-148980 A and JP 2000-149018 A as alternatives to the matching method that uses face templates.

The high grade processing section 28 thus uses red eye candidate detection results and information of red eye candidates in which a face is detected to identify the red eye candidate.

An image in which a face is not detected around any of red eye candidates through face detection is determined as a non-red eye image, and red eye correction of this image halts at this point. Without receiving image correction, the image is deemed as a processed image on which basic processing and red eye correction have been performed.

An identified red eye area receives image processing for red eye correction, and is now treated as a processed image on which basic processing and red eye correction have been performed.

No particular limitation is put on how to correct red eye, and various known methods can be employed. Examples of employable red eye correction methods include processing of controlling the saturation, brightness, hue, and other similar attributes of a red eye area in accordance with an image feature amount or the like of red eye or the perimeter of red eye (which may include the perimeter of the face), and processing of simply changing the color of a red eye area into a specific color, such as black.

Conducting first red eye candidate detection and then face detection only in the surroundings of detected red eye candidates to identify a red eye candidate around which a face is detected as red eye greatly cuts the time needed for red eye detection.

Red eye detection that includes face detection is naturally time-consuming processing. In conventional red eye detection, face detection precedes red eye detection to search a detected face area for red eye. This means that face detection is unnecessarily performed on an area that does not have red eye, which considerably prolongs the time it takes for face detection to finish. In contrast, placing red eye candidate detection before face detection so that face detection is conducted only in an area of given size that contains a detected red eye candidate eliminates the meaningless face detection in an area that does not have red eye and greatly shortens the time necessary for face detection in red eye detection.

The present invention is not limited to this red eye correction method (red eye correction algorithm), and may employ a normal red eye correction method in which red eye detection follows face detection and all other known red eye correction methods.

Not all of apparatuses may employ the same red eye correction method. Some or all of apparatuses may implement different red eye correction methods from one another.

In image formation shown in FIG. 2A, the input machine 10 sequentially performs red eye correction on images (frames) that have received basic processing, thereby turning the images into processed images as described above. Processed images are outputted at a given timing and fed to the output machine 12 as images (image data) to be reproduced on product prints (prints that are actually provided to customers as products).

A half-processed image of an image that is chosen as a promotion subject image is stored in the memory 34. The half-processed image is read out of the memory 34 at a given timing and fed to the promotion processing section 30, which creates an image for a promotion print, to serve as a promotion image. Information of a template chosen for the promotion print is also sent to the promotion processing section 30.

The promotion processing section 30 creates a promotion print image, which is a reproduction of a promotion image placed on a chosen template, and outputs the created image at a given timing (timed to the progress of red eye correction processing for forming a processed image) to feed the created image to the output machine 12. Specifics of promotion processing vary depending on what type of template is chosen.

When the type A template is chosen as a promotion print template, a half-processed image of a promotion subject image is read out of the memory 34 at a suitable point timed to the progress of red eye correction on images in one order, and the read image is fed to the promotion processing section 30.

To create a promotion print using the type A template, a promotion print image is formed by reproducing a half-processed image of a promotion subject image as a promotion image without making any changes to the half-processed image. Then the promotion processing section 30 outputs, as a promotion print, a print on which the promotion image (half-processed image) is reproduced exactly the same way as its corresponding processed image is reproduced on a product print. In preferable image formation for a promotion print, a margin or a blank space is given to the promotion print by using a reduced half-processed image as a promotion image, or by setting the print size of a promotion print larger than that of a product print while using a half-processed image as a promotion image without changing anything about the half-processed image, so that a comment for making the customer aware of the red eye correction performed is printed in the blank space.

Details of the comment are not particularly limited. Examples of the comment include a direct one informing that red eye correction has been performed on the image, information of other frames (images) that have received red eye correction, emphasis on the effect of red eye correction (high grade processing), an ad for a photofinishing laboratory, an ad for a digital photo printer or its manufacturer, photographing tips, a coupon, an ad for a camera, sightseeing/outing information, and a combination of the above.

Preferably, several types of the comment are set in advance so that a selection can be made from plural types. Alternatively, details of the comment may be set arbitrarily. It is also preferable that the print position of the comment, the font, font size, and color of the comment, and the like can be selected and set arbitrarily.

When any one of the type B template, the type C template, and the type D template is chosen as a promotion print template, a processed image of an image that is chosen as a promotion subject image is fed to the promotion processing section 30 at the time red eye correction is finished at the high grade processing section 28. The transfer of the processed image to the promotion processing section 30 is independent of the transfer of the processed image to the output machine 12.

A half-processed image of a relevant promotion subject image stored in the memory 34 is read out of the memory 34 at a given timing (timed to the progress of processing of its corresponding image, for example, upon completion of red eye correction on the image), and is fed to the promotion processing section 30 to serve as a promotion image.

As the processed image and half-processed image of the promotion subject image arrive at the promotion processing section 30, the promotion processing section 30 performs promotion processing using the type B template, the type C template, or the type D template and creates a promotion print image.

First, the promotion processing section 30 determines the sizes of the promotion image and the processed image to be printed on the promotion print in accordance with the chosen template. The half-processed image and processed image of the promotion subject image are resized (size adjustment) until they are as large as the determined sizes. Thus created are a promotion image and a processed image that are to be fit in the template. No particular limitation is put on how to resize the promotion and processed images, and various known methods such as thinning and processing of electronically varying the magnification can be employed. Instead of reducing the promotion and processed images, a portion centered around an area where red eye has been corrected and sized to the determined size on the template may be cut out of the promotion image and the processed image each.

Next, the promotion processing section 30 places the resized promotion image and processed image at their respective positions on the chosen template. Creating a promotion print with the type B, type C, or type D template is similar to creating a promotion print with the type A template in that a promotion print image is formed preferably with the aforementioned comment written in a blank space outside of the image areas.

On a promotion print, a promotion image, a processed image and a comment may be joined, for example, by an enlarged cut-out image of uncorrected and/or corrected red eye as shown in FIG. 3 (a type E template). The enlarged image may be recorded in a blank space, or may be partially or entirely superimposed on the promotion and processed images.

To make sure that a customer notices the presence of a promotion print, the print size of a promotion print is preferably set larger or smaller than that of a product print.

In the above description, as a preferred embodiment, red eye correction (high grade processing) is followed by image resizing to size a promotion image and a processed image to a template. However, the present invention is not limited thereto. In the case where a promotion subject image is selected in advance, this image may be resized for a promotion print before executing basic processing and red eye correction for the promotion print.

A processed image that has received red eye correction (high grade processing) is fed, as mentioned above, from the input machine 10 to the output machine 12 at a given timing as an image to be reproduced on a product print (product image).

Receiving a processed image and a promotion print image from the input machine 10, the output machine 12 pulls out printing paper which is, for example, wound into a roll, cuts the printing paper into a piece sized to the print size, carries the piece of printing paper in a given direction (secondary scan direction), and exposes the printing paper with recording light, which is modulated in accordance with the images fed from the input machine 10, to form a latent image. After developing and drying, a product print on which the processed image alone is reproduced and a promotion print are outputted. The outputted prints are sorted by grouping together prints that have been ordered by a customer at a time. To give a promotion print a different size from a product print, the output machine 12 changes the size of printing paper on which the promotion image is reproduced (by, for example, changing the length of a piece cut out of a roll of printing paper).

Instead of outputting a processed image and a promotion print image to the output machine 12, or in addition to outputting a processed image and a promotion print image to the output machine 12, the input machine 10 may group together a processed image and a promotion print image of an image ordered by the same customer at a time to record the grouped images in a storage medium, and/or to output the grouped images to an external apparatus via a communication network or the like.

Next, a description is given on another embodiment of the present invention in which the input machine 10 automatically selects a promotion subject image through analysis of images (image data) and shooting information (automatic promotion subject image selection).

FIG. 1B is a diagram showing a major part in the structure of the input machine 10 which performs automatic promotion subject image selection.

The input machine 10 in FIG. 1B has the same structure as the input machine 10 in FIG. 1A except for an optimum image determining section 40 for determining which image is optimum as a promotion subject image. The optimum image determining section 40 corresponds to a selection portion, which performs automatic promotion subject image selection as will be described later.

FIG. 2B is a diagram showing the flow of an image forming method that is executed in the input machine 10 of FIG. 1B according to the present invention.

Most of steps in FIG. 2B, namely, image obtainment, display/test, template selection, basic processing, red eye correction, creation of a processed image, reading out half-processed image, and promotion processing, are the same as image obtainment, display/test, template selection, basic processing, red eye correction, creation of a processed image, reading out half-processed image, and promotion processing that are shown in FIG. 2A.

In FIG. 2B, images (frames) are obtained as a group of images that have been ordered by the same customer at a time, and then the display/test step is executed for each of the images in FIG. 2A.

A test image is displayed in the same way a normal digital photo printer displays a test image. Specifically, when an image on film is read by a scanner and fed to the image obtaining section 22, an image obtained through pre-scan, which precedes fine scan for reading an output image, is used to display a test image. In the case of an image photographed by a digital camera or the like, the obtained image is thinned (by skipping portions of the image) or reduced, and the resultant image is used to display a test image.

In the embodiment shown in FIG. 2B, testing is not an indispensable operation, and the digital photo printer may output an image without conducting testing. Two operation modes, a normal mode in which testing is conducted and an automation mode which omits testing, may be set so that one of the two modes can be chosen to output an image.

In the case of reading from film with a scanner, fine scan may be conducted after testing is finished, or may immediately follow pre-scan so that pre-scan and fine scan are executed in succession.

As testing is ended, the input machine 10 next displays a template selecting screen for selecting a template, which serves as a promotion print form (format), thereby prompting the operator to choose a template. A template is selected the same way a template is selected in FIG. 2A.

Basic processing and red eye correction in FIG. 2B are identical with basic processing and red eye correction in FIG. 2A.

When a template is chosen, the basic processing section 26 sequentially performs basic processing on images fed. The images that have received basic processing are provided to the sorting section 31. Images that are found out to be photographed without a flash from shooting information by the sorting section 31, namely, non-red eye images, are separated from the rest in order to avoid sending the non-red eye images to the memory 34. Accordingly, the memory 34 does not keep non-red eye images. Images found out to be non-red eye images at the sorting section 31 do not receive red eye correction in the high grade processing section 28, and deemed as processed images on which red eye correction has been performed.

In the case where the sorting section 31 fails to obtain shooting information or fails to determine from shooting information whether an image is photographed with a flash or not, all images in one order are sent to the high grade processing section 28 to receive red eye correction. At this point, all images, specifically, half-processed images which have received basic processing but not red eye correction, in one order are fed to the memory 34 and stored in the memory 34. To summarize, all of half-processed images in one order, or the some of half-processed images in one order that remain after removing non-red eye images (images that do not need red eye correction since they are found to be photographed without a flash from shooting information), are stored in the memory 34.

Other images than non-red eye images found to be photographed without a flash from shooting information, sequentially receive red eye correction (high grade processing) at the high grade processing section 28 to create processed images.

In the red eye correction step, red eye candidate detection is conducted first and then face detection is performed on the perimeters of red eye candidates. A red eye candidate around which a face is detected is determined as red eye and receives red eye correction. Thus a processed image on which basic processing and red eye correction have been performed is obtained. An image in which no red eye candidate is detected and an image that has a red eye candidate but a face is not detected around the red eye candidate are determined as non-red eye images, and red eye correction of these images halts at this point. Without receiving image correction, the non-red eye images are treated as processed images on which basic processing and red eye correction have been performed.

The optimum image determining section 40 determines an optimum image after red eye correction. The optimum image determining section 40 selects a promotion subject image by deciding, for each image, whether or not the image is optimum as a promotion image.

The result of the red eye detection is used to determine whether an image is optimum as a promotion image. One or more elements are selected from, for example, the size of red eye (the size of the face), whether or not red eye is positioned near the center of the image (the image's main portion), red eye features (color and saturation), whether or not a specific person with red eye appears in plural images in one order (whether the red eye person matters to the customer or not), and the reliability of the red eye correction (height of the judgement value of the red eye candidate detection, face detection, or the like) to make a comprehensive judgment. The optimum image determining section 40 chooses an image that makes it obvious for customers that red eye correction has been performed on an output image through comparison between an image that is considered to make the most impact on customers about the effects of red eye correction, namely, an image that has received red eye correction, and an image that has not received red eye correction. Plural images may be chosen as optimum images for promotion images.

At the time red eye correction is ended, images are sequentially evaluated for their qualification as a promotion subject image with a given determination standard and the result of red eye detection in red eye correction. After every image in one order is evaluated, one image (one frame) that is evaluated highest is chosen as a promotion subject image. Alternatively, a given number of highly evaluated images may be chosen as promotion subject images. There is no need to evaluate images that are found to be photographed without a flash during red eye correction. Images that have no red eye area detected during red eye correction and are thus deemed as non-red eye images are evaluated the lowest in the qualification evaluation.

Accordingly, the input machine 10 keeps all processed images in one order, excluding images found to be photographed without a flash (images that do not need red eye correction), stored in the memory 34 and all half-processed images in the one order stored in the memory 34 until selection of a promotion subject image is finished.

In an example of the qualification evaluation, having a red eye area 2 mm or larger in size on a promotion print is set as a prerequisite, and each image that meets the prerequisite is evaluated for qualification as a promotion image by the distance of the image's largest red eye area from the center of the image (the screen center) In short, an image that has a red eye area 2 mm or larger in size and whose largest red eye area is closer to the center of the image than in any other image is determined as the optimum image and automatically chosen as a promotion image.

An optimum promotion image may be determined by choosing one determination method from several types of determination method prepared. Alternatively, a threshold, a reference value, and other conditions may be set to suit individual cases.

The optimum image determining section 40 sends a promotion subject image chosen as a result of determining an optimum image to the memory 34. Upon reception of the selection result, a corresponding image is picked up from among half-processed images stored in the memory 34, information identifying the half-processed image as a promotion subject image is added, and the half-processed image is fed to serve as a promotion image to the promotion processing section 30, which creates a promotion print image. Some of half-processed images stored as promotion subject images in the memory 34 are deleted if necessary. The memory 34 therefore has to store all of images in one order excluding non-red eye images before optimum image determination is started.

In the case where the type B, type C, or type D template is chosen as a promotion print template, a processed image of an image that is chosen as a promotion subject image is also sent to the promotion processing section 30 separately from output of the processed image to the output machine 12.

After a promotion subject image is chosen, processed images are fed at a given timing to the output machine 12 as images to be outputted onto product prints (finished photo prints).

When a promotion subject image is chosen and a half-processed image of this image is sent to the promotion processing section 30 alone or combined with a processed image of the promotion subject image in this manner, the promotion processing section 30 forms a promotion print image using a previously chosen promotion print template.

Promotion processing in FIG. 2B is identical with promotion processing in FIG. 2A.

When a promotion print is outputted in one order is not particularly limited. For instance, a promotion print is outputted first or last in one order. Preferably, a promotion print is outputted immediately before or after a product print of an image chosen as a promotion subject image in order to make the promotion print most effective in its roll of making the customer aware of the fact that red eye correction (high grade processing) has been performed and of the effect of the red eye correction.

When a product print and a promotion print are outputted in one order can be set by keeping images in the input machine 10 to send the images for prints to the output machine 12 in a given order, or by rearranging the order of images in the output machine 12 to output prints of the images in a given order.

According to the present invention, in image formation that includes high grade processing such as red eye correction, dust/scratch removal, lens aberration correction, and correction of darkening around a photo's edge, an image is chosen, from a group of images related to one another, for example, one order of images on a roll of film or in a recording medium, through analysis of information on the image, to serve as a promotion subject image for demonstrating the effects of high grade processing, and a half-processed image (an image that receives basic processing alone) serving as a promotion image is outputted in addition to an image that receives high grade processing to be printed as a product. Customers are thus made aware of the fact that time/labor-consuming, high-grade processing has been performed and the effects of the high grade processing without fail. In addition, an image that can be used as a promotion subject image is stored in a given memory, which eliminates the need for repeating fine scan or reading images out of a recording medium or the like in order to output a promotion print, and thus makes processing quick.

Accordingly, with the present invention, an added value is given to a print or other similar product, and the image is discriminated from one that does not receive high grade processing. A photofinishing laboratory or the like that employs the present invention can stand out among other stores, compete with other stores in price, and gain and keep new customers.

In the embodiment described above, a promotion subject image is selected by storing, in the memory 34, half-processed images of all images (or all frames photographed with a flash) in one order, and comparing evaluations of all images in one order according to a red eye image determination standard to determine which one of the images is optimum as a promotion image and choose a promotion subject image. However, the present invention is not limited to this embodiment. An alternative way to select a promotion image is to compare images, one image (one frame) at a time, against the evaluation results of images stored in the memory 34 as promotion subject images, store as a promotion subject image a half-processed image that is found as a result of comparison to be better suited in the memory 34, and choose a half-processed image that remains at the end.

Specifically, when basic processing of the first frame image is completed, a half-processed image, which has received basic processing but not high grade processing, of the first frame image is sent to and stored in the memory 34, and simultaneously the half-processed image of the first frame image receives red eye correction at the high grade processing section 28 to turn into a processed image. After red eye correction is finished, the result of red eye detection is used to evaluate the half-processed image according to a determination standard for determining an optimum image as a promotion image. The result of the evaluation is sent to the memory 34.

This alternative method is similar to the above-described embodiment in that images of which shooting information is available and that are found from the shooting information to be photographed without a flash (namely, images that do not need red eye correction) do not have to be sent to the memory 34 and are treated as processed images without receiving red eye correction.

Next, when the basic processing section 26 finishes basic processing of the second frame image, a half-processed image of the second frame image is sent to and stored in the memory 34. The half-processed image of the second frame image also receives red eye correction at the high grade processing section 28 to create a processed image. The processed image of the second frame image which has received red eye correction is evaluated according to the determination standard at the optimum image determining section 40. The optimum image determining section 40 compares the result of the evaluation of the second frame image against the evaluation result of the first frame image which is read out of the memory 34. Information of one of the two images that is evaluated higher than the other and the image's evaluation result are fed to the memory 34 as information of a promotion subject image. The image evaluated higher and the image's evaluation result are stored in the memory 34 as information of a promotion subject image. The other image that is evaluated lower is deleted from the memory 34 along with the image's evaluation result if it has been stored in the memory 34.

Next, the third frame image is processed similarly, and a half-processed image of the third frame image is stored in the memory 34. The half-processed image of the third frame image also receives red eye correction at the high grade processing section 28. The third frame image that has received red eye correction is evaluated at the optimum image determining section 40, and the result of the evaluation of the third frame image is compared against the evaluation result of an image read out of the memory 34 as a promotion subject image. Information of one of the two images that is evaluated higher than the other and the image's evaluation result are fed to the memory 34 as information of a promotion subject image. The image evaluated higher in the comparison and the image's evaluation result are stored in the memory 34 as information of a promotion subject image. The other image that is evaluated lower is deleted from the memory 34 along with the image's evaluation result if it has been stored in the memory 34. Subsequently, similar processing is performed on the fourth frame image, fifth frame image . . . , and an image that remains in the memory 34 at the time all images in one order are processed is chosen as a final promotion subject image. The half-processed image chosen as the final promotion subject image is sent to the promotion processing section 30.

A processed image of the image chosen as the promotion subject image is sent to the promotion processing section 30 in the case where the type B, type C, or type D template is chosen. The processed image on which red eye correction and optimum image determining processing have been performed is also sent to the output machine 12 at a given timing as an image (product) to be reproduced on a product print.

After a half-processed image and processed image of a promotion subject image are sent to the promotion processing section 30 in this manner, a promotion image is formed from the half-processed image or in addition a promotion print image is formed by resizing the processed image to fit in the chosen template as in the method of FIG. 2A. The promotion print image and the processed image that is to be printed on a product print are fed to the output machine 12 at a given timing. The output machine 12 creates a product print on which the processed image is reproduced and a promotion print on which the promotion image is reproduced, and then groups together prints that have been ordered by the same customer at a time. Alternatively, as in the above-described embodiment, the input machine 10 groups together images that have been ordered by the same customer at a time to record the group of images in a recording medium or to output the group of images to an external apparatus via a communication network or the like.

In a case where plural promotion subject images are chosen through the above method which selects a promotion subject image by making evaluation comparison for each image, for example, plural half-processed images will be stored first as promotion subject images in the memory 34, and the evaluation of a newly fed image will be compared against a promotion subject image that has the lowest evaluation among the plural promotion subject images stored in the memory 34 to keep the one having higher evaluation in the memory 34 as a promotion subject image.

Automatic promotion subject image selection according to the above method determines which image is optimum and chooses the image as a promotion subject image. Alternatively, automatic promotion subject image selection can be as follows.

For instance, a given number of images (frames) in which red eye is detected first may be chosen as promotion subject images. Similarly to the above embodiment, evaluation as a promotion subject image may be conducted each time an image finishes red eye correction, an image that is evaluated higher than a suitably set threshold is chosen as a promotion subject image, and selection is repeated until a given number of images are selected.

Several determination standards may be prepared for selection of a promotion subject image which serves as a promotion image so that a suitable one can be chosen from the prepared determination standards. Also, the optimum image determination standard may be set arbitrarily.

Once a promotion subject image is automatically selected and a half-processed image of the promotion subject image is sent to the promotion processing section 30 alone or together with a processed image of the promotion subject image in this manner, the subsequent steps are similar to those in the above-described manual selection: the promotion processing section 30 executes promotion processing to create a promotion print image, and sends the promotion print image to the output machine 12 at a given timing. The output machine 12 creates a product print on which the processed image is reproduced and a promotion print on which the promotion image is reproduced, and then groups together prints that have been ordered by the same customer at a time. Alternatively, as in the above-described embodiment, the input machine 10 groups together images that have been ordered by the same customer at a time to record the group of images in a recording medium or to output the group of images to an external apparatus via a communication network or the like.

In the method of selecting a promotion subject image after red eye correction is finished for all images, and in the method of selecting a promotion subject image through evaluation comparison conducted on one image at a time as well, it is preferable to omit creating a promotion print when no image meets a prerequisite (minimum standard) in determining which image is optimum as a promotion image, for instance, when there is no image that has a red eye area 2 mm or larger in size on a product print as in the above embodiment, since such a promotion print if created does not have sufficient effect.

Red eye correction is performed as high grade processing (the second image processing) in the above description. However, high grade processing in the present invention can be other image processing that corrects various image defects (degradation) than red eye. Desirably, high grade processing can be various types of image processing that corrects only images in which defects are detected as a result of analyzing information on the images. Dust/scratch removal processing, lens aberration correction, and correction of darkening around a photo's edge are particularly desirable examples of high grade processing as mentioned above.

Similarly to red eye correction, these examples of high grade processing can be executed by known methods, which will be described later.

A promotion subject image is selected in the above description either manually (by an instruction input from the operator) or automatically (by analysis of an image and the image's shooting information), but the present invention is not limited thereto. For instance, a digital photo printer to which the present invention is applied is given two operation modes, a manual selection mode and an automatic selection mode, so that a free choice can be made between the manual selection mode and the automatic selection mode. In the manual selection mode, a promotion subject image is selected out of all images in one order in accordance with an instruction entered by the operator through the input operation system 36, and the memory 34 stores the promotion subject image in an unprocessed state in which red eye correction (high grade processing) is omitted. In the automatic selection mode, the memory 34 stores unprocessed images on which red eye correction (high grade processing) has not been performed, excluding images that are found from information on the images to have no need for red eye correction, and a promotion subject image is automatically selected from the images stored in the memory 34 based on the result of analyzing information on the images.

If, in the automatic selection mode, whether or not a flash has been used upon shooting cannot be known for all images in one order from information on the images, the images in one order may all be sent to and stored in the memory 34 in a half-processed state.

The automatic selection mode is labor-saving for operators, improves the productivity and, in addition, enables an unskilled operator to properly select a promotion subject image and create a suitable promotion print stably.

A promotion subject image chosen in the manual selection mode can show substantially the maximum effect of red eye correction, and the manual selection mode allows an operator to choose a promotion subject image that is not chosen through automatic selection. For instance, a photographed image of an infant or a child ruined by red eye is very upsetting to his parents and, for that reason, using this image to show the effect of red eye correction makes a really strong impact on customers. However, in the case where there are many images in one order that are evaluated higher than a red eye image of an infant according to an optimum image determination standard, the red eye image of an infant is not chosen as a promotion subject image in the automatic selection mode. In the manual selection mode, however, an image that is not chosen in automatic selection but is more highly effective in promoting the effect of high grade processing can be chosen as a promotion subject image, which makes it possible to create a more effective promotion print.

Therefore, preparing an automatic selection mode and a manual selection mode, for example, so that selection of a promotion subject image can be switched between manual selection and automatic selection enables to balance improvement in ease of operation and productivity, and versatility of processing/operation with higher grade processing, and thus can improve the effectiveness of a promotion print even more.

Red eye correction is performed as high grade processing (the second image processing) in the above embodiments. However, as mentioned above, high grade processing in the present invention can be other image processing that corrects various image defects than red eye. Desirably, high grade processing can be various types of image processing that corrects only images in which defects are detected as a result of analyzing information on the images. Dust/scratch removal processing, lens aberration correction, and correction of darkening around a photo's edge are particularly desirable examples of high grade processing as mentioned above.

Similarly to red eye correction, these examples of high grade processing can be executed by known methods.

An example of a method employed for dust/scratch removal processing is disclosed in JP 2000-74846 A. In this method, lines that meet a condition are detected by edge detection and used to detect defective portions due to dust or scratches, and the defective portions are repaired by, for example, interpolation using the continuity with surrounding pixels and image data of surrounding areas. JP 2000-92319 A discloses a method in which defect candidate areas due to dust or scratches are detected from how large the difference between a smoothed image and the original image is, defective portions are detected from such features of the candidate areas as changes in shape and color, and the defective portions are repaired in the same way as in JP 2000-74846 A.

A dust/scratch removal method suitably applied to an image that is formed from an image photographed on a photographic film includes, reading an image through normal R (red), G (green), and B (blue) reading and through reading with IR light (infrared radiation) as well, detecting the positions of dust or scratch on the film from the result of IR light reading which is caused by IR light shielded or scattered by the dust or scratch on the film, and repairing defective portions in the same way as in JP 2000-74846 A.

When dust/scratch removal is performed as high grade processing and a promotion subject image is automatically selected as shown in FIG. 25, one or more elements are selected from, for example, the length and thickness of a dust or a scratch, the count of dusts or scratches, whether or not a dust or scratch is located on a face or other major subject of the photograph, and whether or not a dust or a scratch is located near the central portion of the image (the image's major portion) to make a comprehensive judgment from the result of dust/scratch detection. A single image or plural images that are considered to make strong impact regarding the effect of dust/scratch removal processing are selected.

In the case where dust/scratch position detection using IR light is employed as a scratch removal method, an image without an IR light reading image is deemed as an image that does not need dust/scratch removal processing, and a half-processed image of this image is not stored in the memory 34 and is treated as a processed image without receiving dust/scratch removal processing.

An example of a method of lens aberration correction and correction of darkening around a photo's edge is disclosed in JP 11-225270 A. In this method, characteristics of lenses of cameras are obtained and stored in advance, the type of the camera (the type of the lens) used to photograph an image that is to receive correction is identified, and corresponding lens characteristics are retrieved to be used in lens aberration correction and/or correction of darkening around a photo's edge. The type of the lens is identified by analyzing, if the image is formed from an APS film, magnetic information which is read when the image is read with a scanner and, if the image is photographed by a digital camera or the like, various kinds of information recorded in the image's file.

When lens aberration correction and correction of darkening around a photo's edge are performed as high grade processing and a promotion subject image is automatically selected as shown in FIG. 2B, the degree of aberration and darkening, how much aberration and darkening are noticeable, and the like are judged comprehensively to choose a single image or plural images that are considered to make strong impact regarding the effects of lens aberration correction and correction of darkening around a photo's edge. The degree of aberration and darkening, and how much aberration and darkening are noticeable are determined by detecting changes in aberration and darkening from the center of the image to the outside.

In the case where lens aberration correction and correction of darkening around a photo's edge are performed as high grade processing, an image for which the lens type cannot be determined and characteristics of the lens cannot be obtained is deemed as an image that does not need lens aberration correction and correction of darkening around a photo's edge. A half-processed image of this image is not stored in the memory 34 and, without receiving correction, is treated as an image on which high grade processing has been performed.

High grade processing performed on an image in the present invention is not always only one of red eye correction, dust/scratch removal correction, lens aberration correction, and correction of darkening around a photo's edge, but two or more of them may be performed. When there are several types of high grade processing to choose from, which one is to be executed may be selected with buttons, switches, and the like, or by setting work modes.

Depending on what high grade processing is performed or a combination of different types of high grade processing, placing high grade processing on images in one order before basic processing on a promotion subject image is preferable in some cases.

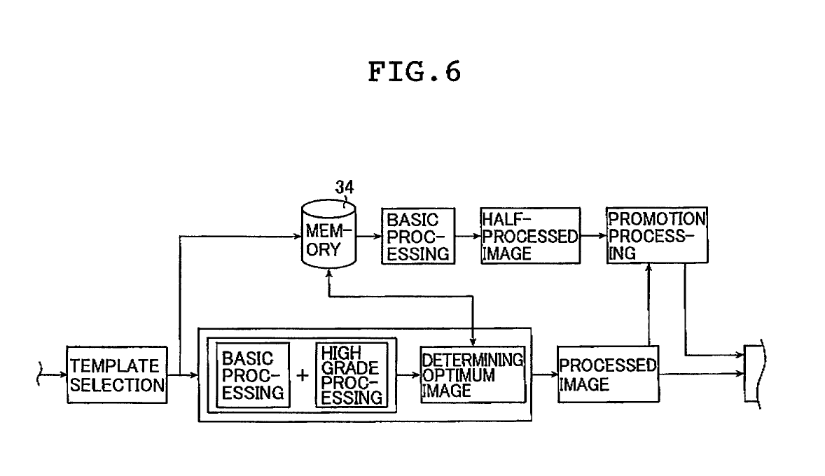

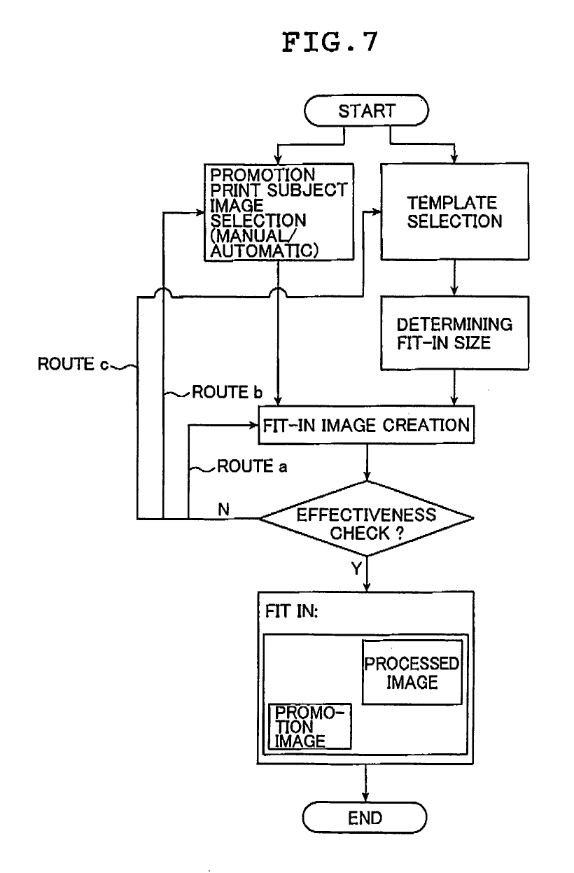

In such cases, as shown schematically in FIG. 6 (where a promotion subject image is selected automatically), selection of a promotion print template is followed by basic processing and high grade processing which are performed on images to obtain processed images, and storing of the unprocessed original image (not processed even by basic processing) in the memory 34. The original image of an image chosen as a promotion subject image is read out of the memory 34, receives basic processing to turn into a half-processed image, and then into a promotion image through promotion processing.

The present invention is not limited to image formation on a photo print using printing paper, but is applicable to image formation (creation of a print (hard copy)) in printing machines, printers that use a heat-sensitive recording medium, printers that use a photosensitive/heat-sensitive recording medium, printers that use a photosensitive medium, ink jet printers, electrophotographic printers, and the like.

Different recording media and different image recording methods (drawing methods) may be employed for a product print and a promotion print. However, considering the texture of a promotion print and the role of a promotion print which is to demonstrate the effect of high grade processing through comparison against a product print, it is preferable to create a promotion print using the same recording medium and image recording method that are employed for a product print. In creating a photo print, in particular, outputting a promotion print as a photo print by recording a promotion image on a piece of printing paper is preferable in terms of the texture of a promotion print, customer satisfaction, the effectiveness in demonstrating the effect of high grade processing, and the like.

If the image formation method employed allows, an image may be formed on either face of a print (hard copy). For instance, a print with a processed image (product image) reproduced on the front face and a promotion image reproduced on the rear face may be outputted as a promotion print or a product print.

In the present invention, it is more desirable if the effect of high grade processing and the effectiveness of a promotion print in demonstrating the effect of high grade processing can be checked on the display 32 before the promotion print is outputted by displaying a promotion print image on the display 32 alone or together with a product print image.

A similar service is preferably provided in an unattended photographic apparatus which is set up at the storefront or the like, a print producing apparatus which is set up at the storefront, a photo print order receiving machine which is set up at the storefront, etc.

Lastly, a description is given on an embodiment different from the embodiments shown in FIGS. 2A and 2B in regard to promotion processing performed to create a promotion print image.

FIG. 7 is a diagram showing the flow of another embodiment of promotion processing in the promotion processing section 30.

In FIG. 7, similarly to the flow of the embodiments described above, a promotion subject image is selected after testing, a promotion print template is selected, and information of the choices is fed to the promotion processing section 30.

By the time promotion processing is started, a promotion subject image has been selected and a half-processed image of this image has been obtained. Through promotion processing, the sizes of a processed image and half-processed image of the promotion subject image to be fit in a promotion print are determined in accordance with the type (the type B, C or D shown in FIG. 3) of the chosen template (a step of determining a fit-in size).

The processed image and half-processed image of the promotion subject image that is selected manually or automatically are resized (size adjustment) to the determined fit-in sizes. Thus created to be fit in the template, namely, the promotion print, are fit-in images of the processed image and of the half-processed image. The fit-in image of the half-processed image serves as a promotion image.

To resize the images, the images are reduced or portions of the images are cut out. In the example shown in FIG. 7, the images are resized by reduction. Considering the image quality, it is preferable to reproduce the entirety of a promotion subject image on a promotion print, and therefore resizing by reduction is preferred to resizing by cutting out. Different resizing methods may be employed for the processed image and the half-processed image: for instance, the processed image is resized by reduction whereas the half-processed image is resized by cutting out an area around red eye. No particular limitation is put on how to reduce an image, and various known methods such as thinning and processing of electronically varying the magnification are employable.

In the case where a fit-in image is formed by cutting out a portion of an image, the cut out area has to be as large as to contain red eye at least. Desirably, a cut out portion covers the entire face and, more desirably, satisfies a face balance, which will be described later.

Next, whether or not the promotion image (the fit-in image of the half-processed image) is effective in demonstrating the effect of red eye correction is checked.

For instance, the effectiveness of a promotion image is checked by performing red eye detection on the promotion image exactly the same way as in the previous red eye correction. If red eye is detected in the promotion image as a result of the red eye detection, it is judged that red eye of the original image is reproduced favorably in the promotion image and that the promotion image is accordingly effective in demonstrating the effect of red eye correction (“Y” in FIG. 7). On the other hand, if red eye is not detected in the promotion image, it is judged that red eye of the original image is not reproduced in the promotion image and that the promotion image is not effective in demonstrating the effect of red eye correction (“N” in FIG. 7).

When the effectiveness of the promotion image is confirmed (“Y”), a promotion print image (image data) made up of the created fit-in image of the processed image and the promotion image (image to be fit in the template) is formed as shown in FIG. 7. The type B template is used as an example in FIG. 7.

After the promotion print image is formed at the promotion processing section 30, the input machine 10 sends the promotion print image to the output machine 12 at a given timing as in outputting a processed image which is to be reproduced on a product print.

A promotion print image may be composed solely of a processed image and a promotion image, but preferably has, in a margin of the template, a comment that makes a customer aware the fact that red eye correction has been performed.

Details of the comment are not particularly limited. Examples of the comment include a direct one informing that red eye correction has been performed on the image, information of other frames (images) that have received red eye correction, emphasis on the effect of red eye correction (high grade processing), an ad for a photofinishing laboratory, an ad for a digital photo printer or its manufacturer, photographing tips, a coupon, an ad for a camera, sightseeing/outing information, and a combination of the above.

Preferably, several types of the comment are set in advance so that a selection can be made from plural types. Alternatively, details of the comment may be set arbitrarily. It is also preferable that the print position of the comment in the promotion print, the font, font size, and color of the comment, and the like can be selected and set arbitrarily.

An enlarged image of a red eye portion cut out of an uncorrected and corrected image may be recorded in a promotion print image as shown in the type E template of FIG. 3. The enlarged image may be recorded in a blank space, or may be partially or entirely superimposed on the promotion and processed images. The enlarged image may instead be recorded on a promotion print where the promotion image alone is reproduced.

The enlarged image may be created in accordance with an inputted instruction, or a template having the enlarged image may be prepared to be selected from among other templates.

A promotion print image is preferably formed such that a promotion print is larger in size than a product print, or such that a promotion print is smaller in size than a product print.

Giving a promotion print a different size from a product print makes the promotion print easier to be noticed by customers. The benefit of setting the size of a promotion print larger than the size of a product print is that, this way, the promotion print asserts its presence. The benefit of setting the size of a promotion print smaller than the size of a product print is to keep the cost from rising by reducing consumption of printing paper (the assumption here is that promotion prints are usually outputted for free (customers are not charged for promotion prints)).

The size of a promotion print may be selected from the same size as a product print, a smaller size than a product print, and a larger size than a product print. Alternatively, a promotion print may be set to an arbitrary size.

This applies also to a case of outputting an image (data) to a recording medium or the like.

When it is judged as a result of checking the effectiveness of a promotion image that the promotion image is not effective in demonstrating the effect of high grade processing (“N” in FIG. 7), in other words, when red eye is not detected in the promotion image, a promotion image is formed anew.

In the promotion processing shown as an example in FIG. 7, there are three methods, a route a, a route b, and a route c, for forming a promotion image anew.

With the route a, a new promotion image is formed by changing how a promotion image (fit-in image) is formed from a half-processed image.

In the case of forming a promotion image by reducing a processed image as described above, a method of changing how the processed image is reduced is given as an example. For instance, if the first, ineffective promotion image is formed by thinning the half-processed image, a new promotion image is formed by processing of electronically varying the magnification that involves interpolation instead of thinning. Another preferable way to form a promotion image anew is to employ more advanced computations (e.g., higher-order processing computations) than employed for the first, ineffective promotion image. By thus changing how to reduce an image in creating a new promotion image that replaces a first create promotion image which is ineffective, the new promotion image is likely to have red eye of the original image that is properly reproduced and be effective in demonstrating the effect of red eye correction.

In the case where the first, ineffective promotion image is formed by resizing through reduction, a new promotion image may be formed by cutting out an area around a red eye portion instead of reduction. This method makes the red eye area in the new promotion image equal in size to the red eye area in the half-processed image, and therefore the new promotion image is checked out to be effective without fail. On the other hand, this method cannot avoid lowering of the quality since the promotion image is only partially reproduced as mentioned above.

The route b is effective when there are plural promotion print templates to choose from. The route b is for switching types of promotion print template.

For instance, the type B template shown as an example in FIG. 3 makes a promotion image smaller than a processed image. Accordingly, red eye in a promotion image formed by reduction is very small and may not be detected while it has had easily been detected in red eye correction before reduction. In such cases, templates are switched. If a type D template, for example, with which a promotion image is reproduced larger than a processed image, is chosen to form a promotion image anew, red eye in the new promotion image is likely to be large enough to be detectable. To summarize, in the case where a promotion image created with a certain template is found to be ineffective in demonstrating the effect of high grade processing, employing a different template is likely to produce an effective promotion image in which red eye of the original image is reproduced properly.

When forming a promotion image anew with a template different from the one used first, the processed image of the promotion subject image is, if necessary, resized in accordance with the newly chosen template to form a new fit-in image.

The route c is for forming a promotion image anew by a fundamental switch from the current promotion subject image to another promotion subject image (reselection of a promotion subject image).

Different original images have different red eye sizes and states. Therefore, particularly when a promotion subject image is employed by manual selection, or by automatic selection without the optimum image determination described above, forming a promotion image anew from a promotion subject image different from the current one is likely to produce an effective promotion image in which red eye of the original image is reproduced properly.

When forming a promotion image anew from a promotion subject image different from the one used first, the processed image of the newly chosen promotion subject image has to be resized to form a new fit-in image.

Promotion subject image reselection of the route c for forming a promotion image anew is not limited to a particular method, and is not limited by a method employed to select the first promotion subject image (manual selection or automatic selection).

For instance, an alert message informing that the promotion image formed is inadequate is displayed on the display 32, and then a promotion subject image reselecting screen is displayed to prompt the operator to enter a reselection instruction. A new promotion subject image is thus selected in accordance with the inputted instruction of the operator (manual reselection). In another example, a new promotion subject image is reselected through image analysis or the like by changing the determination condition (selection condition) (automatic reselection). In still another example, a choice can be made between manual reselection and automatic reselection.

There is no particular limitation in the present invention in choosing which one of the routes a to c is to be used to form a promotion image anew. The operator may choose how to form a new promotion image. Alternatively, how and in what order a new promotion image is to be formed may be set in advance. It is also possible to automatically choose, through image analysis of the current promotion image and/or image analysis of other half-processed images than the current promotion subject image, a method of forming a new promotion image that is, without fail, proved to be effective in the step of checking the effectiveness in demonstrating the effect of high grade processing.

The routes may be selected suitably, and the operator may be allowed to choose between selecting a route for a new promotion image and forming a new promotion image as directed by settings. In the case of setting in advance a route for forming a promotion image anew, including a case of additionally setting the order of the route, the route and its order may be set arbitrarily.

The design of a promotion print image may be established once a promotion image is formed anew. Then the new promotion image and the processed image are fit in their respective places in a template to form the promotion print image, which is fed from the input machine 10 to the output machine 12 at a given timing.

However, it is preferable to check, before forming a promotion print image, a newly formed promotion image for its effectiveness in demonstrating the effect of high grade processing the same way the first promotion image is checked. If the effectiveness of the new promotion image is confirmed, this promotion image is used to form a promotion print image. If the new promotion image is found to be ineffective, another promotion image is formed and checked for its effectiveness. This process is repeated until an effective promotion image is obtained. The thus formed promotion print image is fed from the input machine 10 to the output machine 12 at a given timing.

In the case where a promotion image that is confirmed to be effective in demonstrating the effect of high grade processing is not obtained despite repeatedly forming a promotion image anew, an effective promotion image is not likely to be formed from any image in this order. Therefore, it is preferable to stop trying to create a promotion print for an order when a promotion image that is confirmed to be effective in demonstrating the effect of high grade processing is not obtained by repeating a given number of times the process of forming a promotion image anew. How many times the process of forming a promotion image anew is to be repeated before the attempt to create a promotion print is given up is determined to suit a system or the like to which the present invention is applied. Alternatively, it may be variable in accordance with the number of images, the number of red eye images, or the like.

As mentioned above, a processed image on which red eye correction has been performed is sent from the input machine 10 to the output machine 12 at a given timing as a product image, which is an image to be reproduced on a product print. A promotion print image created is also sent from the input machine 10 to the output machine 12 at a given timing.

Receiving a processed image and a promotion print image from the input machine 10, the output machine 12 pulls out printing paper which is, for example, wound into a roll, cuts the printing paper into a piece sized to the print size, carries the piece of printing paper in a given direction (secondary scan direction), and exposes the printing paper with recording light, which is modulated in accordance with the images fed from the input machine 10, to form a latent image. After developing and drying, a product print on which the processed image alone is reproduced and a promotion print are outputted. The outputted prints are sorted by grouping together prints that have been ordered by a customer at a time.

Instead of outputting a processed image (product image) and a promotion print image to the output machine 12, or in addition to outputting a processed image and a promotion print image to the output machine 12, the input machine 10 may group together a processed image and promotion print image of an image ordered by the same customer at a time to record the grouped images in a storage medium, and/or to output the grouped images to an external apparatus via a communication network or the like.

When to output a promotion print in outputting prints (images) in one order is not particularly limited. For instance, a promotion print is outputted first or last in one order. Preferably, a promotion print is outputted immediately before or after a product print of an image chosen as a promotion subject image in order to make the promotion print most effective in its role of making the customer aware of the fact that red eye correction (high grade processing) has been performed and of the effect of the red eye correction.

When to output a product print and a promotion print in outputting prints in one order can be set by sending the images kept in the input machine 10 for prints to the output machine 12 in a given order, or by rearranging the order of images in the output machine 12 to output prints of the images in a given order.

In the above embodiment, the effectiveness of a promotion print in demonstrating the effect of red eye correction is checked by detecting red eye in a created promotion image. However, the present invention is not limited thereto, and various other methods can be employed to check the effectiveness.

For instance, a promotion image is judged to be effective in demonstrating the effect of red eye correction (“Y”) when red eye is detected in the promotion image and the red eye size is detected to be equal to or larger than a given value whereas it is judged as ineffective (“N”) when the red eye size is lower than the given value. In the case where a promotion image is found to be ineffective, a new promotion image is formed in the manner described in the above embodiment.

When the size of red eye in a promotion image is found to be smaller than a given size in the course of checking the effectiveness of the promotion image by detecting the size of red eye in the promotion image, instead of (or in addition to) forming a promotion image anew, an enlarged image like the type E shown in FIG. 3 may be reproduced (or the type E template may be chosen automatically).

A template for reproducing an enlarged image like the type E template shown in FIG. 3 may be chosen automatically as soon as the red eye size in a promotion image is found from the result of red eye detection to be lower than a given value.

Another preferable method of checking the effectiveness of a promotion image is to check the face balance in the promotion image after the promotion image is formed. By checking the appropriateness of the face balance in a promotion image, a promotion image obtains excellent image quality and accordingly more effectiveness in demonstrating the effect of high grade processing. This method is particularly suitable to a case in which a promotion image is obtained by cutting out an area centered around a face.

No particular limitation is put on how to check the face balance. For instance, face detection is performed in the manner described above to detect the entire size of the image and the size and location of a face in the image. When the size of a promotion image in the lateral direction of a face is given as A, the image's size in the longitudinal direction of the face is given as B, the distance between the upper end of the face and the upper end of the image is given as L1, and the distance between a lateral end of the face and a lateral end of the image is given as L2, the following expressions are obtained:
A×0.05<L2<A×0.1
B×0.05<L1<B×0.1

A promotion image that satisfies both the expressions is judged as effective (“Y”), and a promotion image that fails to satisfy either one of the two is judged as ineffective (“N”). In the case where a promotion image is found to be ineffective, a new promotion image is formed by one of the methods described above, by cutting out a different area, or by enlarging/reducing the cut out image.

It is also possible to use the red eye size and the face balance both for checking the effectiveness of a promotion image and for forming a promotion image anew.

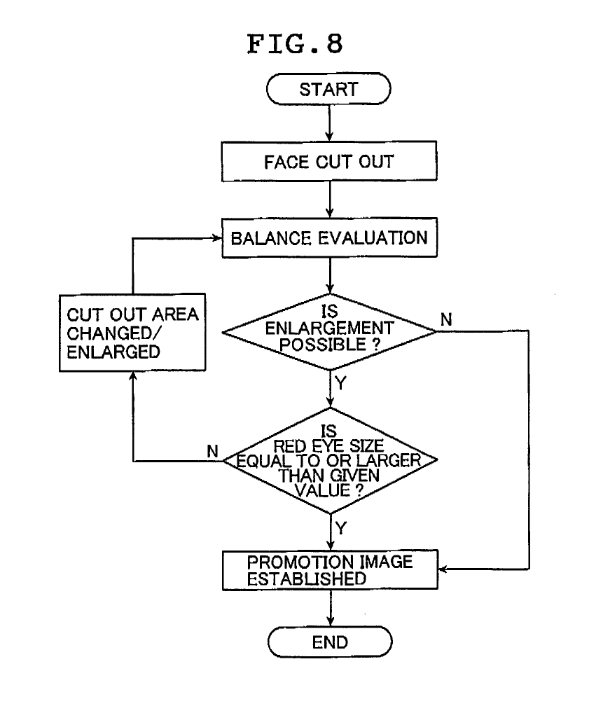

To give an example, when promotion image is formed by cutting a face area out of a half-processed image of a promotion subject image, the promotion image is first evaluated for face balance as in the flow shown in FIG. 8. Then it is judged whether or not the current image can be enlarged by narrowing the cut out area while keeping the face balance appropriate. In the case where further enlargement breaks the face balance (enlargement not possible (“N”)), this image is fit as a promotion image in a template to form a promotion print image (promotion image established).

In the case where the current image can be enlarged (enlargement possible (“Y”)), whether or not the red eye size is equal to or larger than a given value is checked next. When the red eye size is equal to or larger than the given value (“Y”), this image is established as a promotion image. When the red eye size is lower than the given value (“N”), the cut out area is narrowed (cut out area changed), and the cut out image is enlarged in accordance with a template to form a promotion image anew. Subsequently, the same process (checking whether or not enlargement with the face balance maintained is possible, establishing the current image as a promotion image when enlargement is not possible, detecting the red eye size when enlargement is possible, establishing the current image as a promotion image when the red eye size is equal to or larger than a given size, and changing and enlarging the cut out area when the red eye size is smaller than the given size to form a promotion image anew) is repeated.

In the above description, red eye correction (high grade processing) is followed by sizing of a processed image and a promotion image to a chosen template (resizing). However, the present invention is not limited thereto. In a case where a promotion subject image is selected in advance, a promotion image may be resized to the promotion print size prior to basic processing and high grade processing for creating a promotion print.

Examples of high grade processing other than red eye correction include dust/scratch correction, lens aberration correction, and correction of darkening around a photo's edge.

To check the effectiveness of a promotion image in demonstrating the effect of dust/scratch correction, the image analysis described above is employed to detect a defective portion due to dust or a scratch in a promotion image formed. A promotion image in which a defective portion is detected is judged as effective (“Y”), and a promotion image in which no defective portion is detected is judged as ineffective (“N”). In the case where a promotion image is found to be ineffective, a new promotion image is formed by the same methods as those given in the above description of red eye correction.

To check the effectiveness of a promotion image in demonstrating the effect of lens aberration correction, for instance, whether or not a correction coefficient or correction amount for correcting the aberration exceeds a given threshold is detected. A promotion image is judged as effective (“Y”) when the threshold is exceeded, and is judged as ineffective (“N”) when the correction coefficient or the correction amount is equal to or lower than the threshold.

To check the effectiveness of a promotion image in demonstrating the effect of correction of darkening around a photo's edge, for instance, whether or not a darkening correction coefficient or darkening correction amount at the outer most portion of the photo exceeds a given threshold is detected. A promotion image is judged as effective (“Y”) when the threshold is exceeded, and is judged as ineffective (“N”) when the correction coefficient or the correction amount is equal to or lower than the threshold. Alternatively, the pixel value (e.g., average value) in a certain surface area of the photo's central area is compared against the pixel value in a certain surface area of the photo's perimeter to obtain the difference between the two areas. A promotion image is judged as effective (“Y”) when the difference exceeds a given threshold, and is judged as ineffective (“N”) when the difference is equal to or lower than the threshold.

In the case where a promotion image is found to be ineffective, a new promotion image is formed by the same methods as those given in the above description of red eye correction.

High grade processing performed on an image in the present invention is not always only one of red eye correction, dust/scratch removal correction, lens aberration correction, and correction of darkening around a photo's edge, but two or more of them may be performed.

Depending on what high grade processing is performed or a combination of different types of high grade processing, placing high grade processing on images for product prints(or a part thereof) before basic processing on a promotion subject image is preferable in some cases.

In such cases, as shown schematically in FIG. 6, selection of a promotion print template is followed by basic processing and high grade processing which are performed on images to obtain processed images for product prints and, concurrently, storing of the images on which basic processing has not been performed (original images) in the memory 34. The original image of an image chosen as a promotion subject image is read out of the memory 34, receives basic processing to turn into a half-processed image, and then into a promotion image through promotion processing.

As is clear from the above description, according to the present invention, in image formation that includes high grade processing such as red eye correction, dust/scratch removal, lens aberration correction, and correction of darkening around a photo's edge, an image is chosen, from a group of images related to one another, for example, one order of images on a roll of film or in a recording medium, to serve as a promotion image which receives basic processing alone, and a processed image which receives high grade processing is outputted in addition to the promotion image. A customer who orders prints or the like of the images is thus made aware of the fact that time/labor-consuming, high-grade processing has been performed and the effects of the high grade processing without fail. In addition, an image that has received basic processing alone, or an unprocessed image (original image) is stored in a given memory and read out of the memory to form a promotion print image, which eliminates the need for repeatedly reading an image from its original source, and thus makes it possible to effectively create a promotion print with simple processing.

Moreover, after a promotion image is formed, whether or not the promotion image is effective in demonstrating the effect of high grade processing is checked and, if the promotion image is found to be ineffective, a new promotion image is formed by changing conditions. Preferably, the process of forming a promotion image anew is repeated until a promotion image that is confirmed to have a given level of effectiveness is obtained. Thus, the effect of high grade processing can be surely and fully demonstrated to customers in a more stable manner.

Accordingly, with the present invention, an added value is given to a print or other similar product, and the image is discriminated from one that does not receive high grade processing. A photofinishing laboratory or the like that employs the present invention can stand out among other stores, compete with other stores in price, and gain and keep new customers.

An image forming method and image forming apparatus of the present invention have been described above in detail. However, the present invention is not limited to the above embodiments, and various improvements and modifications can be made without departing from the spirit of the present invention.

What is claimed is:

1. A method of forming an image by performing image processing on each of optically photographed images that belong to one group, comprising the steps of:
performing first image processing and then second image processing on a specific image out of all the images in one group to create a processed image;
storing, in a given memory, at least one image including the specific image out of all the images in one group as an unprocessed image on which at least the second image processing has not been performed; and
reading the specific image stored as the unprocessed image in the memory to output, along with the processed image, a half-processed specific image which is obtained by performing the first image processing but not the second image processing on the specific image.

2. The image forming method according to claim 1,
wherein the half-processed specific image is stored in the memory as an unprocessed image, and
wherein in creating the processed image by performing the first image processing and then the second image processing on the specific image and outputting the processed image, the half-processed specific image is read out of the memory, in concert with the progress of the second image processing for creating the processed image, to be outputted with the processed image.

3. The image forming method according to claim 1,
wherein an unprocessed specific image that has not received the first image processing is stored in the memory, and
wherein in creating the processed image by performing the first image processing and then the second image processing on the specific image and outputting the processed image, the unprocessed specific image that has not received the first image processing is read out of the memory in concert with the progress of the second image processing for creating the processed image, the first image processing is performed on the read image to create the half-processed specific image, and the half-processed specific image are outputted with the processed image.

4. The image forming method according to claim 1,
wherein the specific image is chosen out of all the images in one group in accordance with an inputted instruction, and
wherein the memory stores the chosen half-processed specific image, which has not received the second image processing.

5. The image forming method according to claim 1,
wherein the memory stores half-processed images of all images in one group except an image for which the second image processing is judged as unnecessary from information on the image, and
wherein the specific image is automatically chosen, out of the half-processed images that the memory stores, in accordance with the result of analyzing information on the image in a preset manner.

6. The image forming method according to claim 5, wherein the information on the image is one of image data, the image's shooting information, and both thereof.

7. The image forming method according to claim 1, wherein all the images in one group, including the specific image, are stored in the memory.

8. The image forming method according to claim 1,
wherein one of a first mode and a second mode is chosen to form an image,
wherein, in the first mode, the specific image is chosen out of all the images in one group in accordance with an inputted instruction, and the memory stores the unprocessed specific image that has not received the second image processing, and
wherein, in the second mode, the memory stores such an unprocessed image that has not received the second image processing and that is not an image for which the second image processing is judged as unnecessary from information on the image, and the specific image is automatically chosen, out of images stored in the memory, in accordance with an analysis result obtained by analyzing information on the image.

9. The image forming method according to claim 1,
wherein one of a first mode and a second mode is chosen to form an image,
wherein, in the first mode, the specific image is chosen out of all the images in one group in accordance with an inputted instruction, and the memory stores the unprocessed specific image that has not received the second image processing, and
wherein, in the second mode, the memory stores all unprocessed images in one group that have not received the second image processing.

10. The image forming method according to claim 1, wherein the second image processing is processing for analyzing information on an image and repairing a defect of an image when an image defect is detected in the image from the result of analyzing information on the image.

11. The image forming method according to claim 1, wherein the second image processing includes at least one correction selected from the group consisting of red eye correction, dust/scratch removal, aberration correction due to a lens used to photograph an image, and correction of darkening around an image's edge due to a lens used to photograph the image.

12. The image forming method according to claim 1, wherein, in outputting the half-processed image with the created processed image, each of a hard copy on which the processed image is reproduced and a hard copy on which the half-processed specific image is reproduced is outputted to an identical type of recording medium by an identical image recording method.

13. The image forming method according to claim 12, wherein the recording medium is printing paper.

14. The image forming method according to claim 1, wherein the processed image is reproduced on one side of a hard copy and the specific image in an unprocessed state is reproduced on the other side of the hard copy.

15. The image forming method according to claim 1, wherein the specific image is a reference image with which the effect of the second image processing is measured, and is automatically chosen out of all the images in one group by analyzing information on the image.

16. The image forming method according to claim 15,
wherein the specific image is automatically chosen in accordance with the result of analyzing information on the image, and
wherein the memory stores such an unprocessed specific image that has not received the second image processing and that is other than an image for which the second image processing is judged as unnecessary from the analysis result, or the memory stores all the unprocessed images in one group are fed to the memory.

17. The image forming method according to claim 16, wherein after all images in one group are stored in the memory, the specific image is chosen out of all the images fed.

18. The image forming method according to claim 15,
wherein all the images in one group receive the second image processing in an order that the images are fed,
wherein a first image of the images in one group that has received the second image processing earlier than any other images in the group is evaluated in accordance with a preset determination standard from the result of the image processing, and the result of the evaluation is stored in the memory,
wherein a second and subsequent processed images on which the second image processing has been performed are sequentially evaluated in accordance with the determination standard, and a process in which, each time the evaluation is made, the result of the evaluation is compared against the evaluation result stored in the memory to store the higher one of the two evaluations in the memory is repeated until the processed image that has been fed last is evaluated, and
wherein an image whose evaluation result remains stored in the memory at the end is chosen as the specific image.

19. The image forming method according to claim 1, further comprising the step of checking whether the half-processed specific image is effective in demonstrating the effect of the second image processing,
wherein, when the half-processed specific image is confirmed to be effective, the specific image is reproduced and, when the specific image is found to be ineffective, a new specific image is formed under different conditions from conditions under which the ineffective specific image is formed.

20. The image forming method according to claim 19, wherein the forming of a new specific image is repeated until the repetition count reaches a given number of times, and if an effective specific image is not obtained at that point, an attempt to form a half-processed specific image anew is stopped.

21. The image forming method according to claim 19, wherein the forming of a new specific image is performed by changing at least one of previous conditions of forming the half-processed specific image, a format of reproducing the half-processed specific image, and an image to be selected as the specific image.

22. The image forming method according to claim 19,
wherein the second image processing is red eye correction in which red eye in an image is detected to correct the detected red eye, and
wherein, the effectiveness of the specific image in demonstrating the effect of the second image processing is judged by whether the specific image has detectable red eye, and the specific image is deemed as effective when red eye is detected whereas the specific image is deemed as ineffective when red eye is not detected.

23. An image forming apparatus, comprising:
an image obtaining section for obtaining, in groups, optically photographed images, each group containing plural images;
a processing section for executing, on an obtained image, one of first image processing, second image processing, and both, in which case the second image processing is performed after the first image processing;
a selection section for selecting, by analyzing information on images, which of the images in one group is to serve as a specific image, the specific image being a reference image with which the effect of the second image processing is demonstrated;
a memory for storing an image chosen by the selection section as a specific image or all images fed including the specific image; and
a sorting section for sending, to the memory, all the images in one group, or all the images in one group except an image for which the second processing is judged as unnecessary from the result of analyzing information on the image, in one of a state before the first processing image is performed and a half-processed state in which the first image processing alone has been performed,
wherein an image that is chosen by the selection section as a specific image is read out of the memory, and a half-processed specific image which is obtained by performing the first image processing but not the second image processing at the processing section is outputted along with a processed image which is obtained by performing the first image processing and the second image processing on the specific image at the processing section.

24. The image forming method according to claim 23, wherein the memory stores all images fed, and the selection section selects the specific image after images in one group are all fed to the memory.

25. The image forming method according to claim 23,
wherein images are fed to the processing section sequentially to receive the second image processing,
wherein the memory stores at least one image in one group, and also stores result of evaluation made on the stored image to evaluate the effect of the second image processing in accordance with an evaluation standard, and
wherein the selection section obtains the result of evaluation made in accordance with the evaluation standard on processed image, which have sequentially been fed and received the second image processing, and, each time the evaluation is made, the result of the evaluation is compared against an image's evaluation result stored in the memory, an image that is evaluated higher than the other is stored in the memory as the specific image, thereby replacing the previously stored image, and the selection section ultimately determines, as a specific image, an image that remains stored in the memory when the evaluation result comparison is finished for the image that has been fed last out of the fed images.

26. An image forming apparatus, comprising:
an image obtaining section for obtaining, in groups, optically photographed images, each group containing plural images;
a processing section for executing, on an obtained image, one of first image processing, second image processing, and both, in which case the second image processing is performed after the first image processing;
a selection section for selecting, from images in one group, at least one image as a specific image; and
a memory for storing an unprocessed image that has not received the second image processing;
wherein the specific image is stored as an unprocessed image in the memory, the specific image is read out of the memory, and a half-processed specific image which is obtained by performing the first image processing but not the second image processing is outputted with a processed image which is obtained by performing the first image processing and the second image processing on the specific image.

27. The image forming apparatus according to claim 26, wherein the memory stores the half-processed specific image and the half-processed specific image is read out of the memory and outputted.

28. The image forming apparatus according to claim 26, wherein the memory stores as the unprocessed image the specific image which has not received the first image processing, and the stored unprocessed specific image is read out of the memory to receive the first image processing before outputted.

29. The image forming apparatus according to claim 26,
wherein the selection section has at least one of a first selection section for selecting the specific image in accordance with an instruction inputted by an operator and a second selection section for selecting the specific image by analyzing information on the image.

30. The image forming apparatus according to claim 26,
wherein the selection section has a first selection section for selecting the specific image in accordance with an instruction inputted by an operator, and a second selection section for selecting the specific image by analyzing information on the image, and which one of the selection sections is to operate is selected.
